(19) United States
(12) Patent Application Publication
(10) Pub. No.: US 2021/0230001 A1
(43) Pub. Date: Jul. 29, 2021

(54) SYSTEM AND METHOD FOR SCALED-UP SYNTHESIS OF DOPED AND FUNCTIONALIZED GRAPHENE DERIVATIVES THROUGH MECHANICAL EXFOLIATION PROCESS

(71) Applicant: LOG 9 MATERIALS SCIENTIFIC PRIVATE LIMITED, BENGALURU (IN)

(72) Inventors: AKSHAY VIVEK SINGHAL, DEOBAND (IN); ANSHUL KUMAR SHARMA, PALAMPUR (IN); AYUSHI KAUSHIK, DHANAURA (IN)

(21) Appl. No.: 17/259,547

(22) PCT Filed: Jul. 9, 2019
(86) PCT No.: PCT/IN2019/050505

§ 371 Date: Jan. 12, 2021

(30) Foreign Application Priority Data
Jul. 9, 2018 (IN) 201811000944

(51) Int. Cl. C01B 32/19; C01B 32/194

(52) U.S. Cl. CPC C01B 32/19; C01B 32/194

(57) ABSTRACT

The embodiments herein provide method and system for synthesizing graphene and a plurality of derivatives through a mechanical shearing process. The method comprises synthesizing a ceramic substrate from a ceramic material in particulate form; depositing carbon material on the synthesized ceramic substrate to synthesize graphene ceramic substrate coated with carbonaceous material; dissolving/dispersing the graphene ceramic substrate coated with carbonaceous material in one solvent and perform mechanical shearing to obtain a dispersion solution of graphene and its derivatives. This graphene dispersions is further subjected to ultrasonication to obtain graphene nano-platelets. The embodiments also provide mechanical exfoliation method for the bulk synthesis of doped and functionalized graphene nano-platelets. The doped graphene ceramic composite are subjected to exfoliation with or without simultaneous ultra-sonication for obtaining doped graphene sheet. The exfoliated graphene sheets obtained from doped graphene ceramic composite are subjected to ultra-sonication and centrifugation.

### CROSS-REFERENCE TO RELATED APPLICATIONS

The present application is a National Phase Application of the PCT application with the serial number PCT/IN2019/050505 filed on Jul. 9, 2019 with the title, “A SYSTEM AND METHOD FOR BULK SYNTHESIS OF GRAPHENE AND DERIVATIVES”, and the PCT application with the serial number PCT/IN2019/050814 filed on Nov. 4, 2019 with the title, “A SYSTEM AND METHOD FOR SCALED-UP SYNTHESIS OF DOPED AND FUNCTIONALIZED GRAPHENE DERIVATIVES THROUGH MECHANICAL EXFOLIATION PROCESS”. The contents of both the PCT applications with the serial number PCT/IN2019/050505 and PCT/IN2019/050814 are included in entirety as reference herein. The PCT application with the serial number PCT/IN2019/050505 is filed in continuation of the Indian Provisional Patent Application (PPA) with serial number 201811000944 filed on Jan. 9, 2018 and subsequently postdated by 6 Months to Jul. 9, 2018 with the title, “BULK SYNTHESIS OF GRAPHENE AND A PLURALITY OF DERIVATIVES BY A MECHANICAL SHEARING PROCESS”, and the contents of abovementioned PPA are included in entirety as reference herein. The PCT application with the serial number PCT/IN2019/050814 is filed in continuation of the Indian Provisional Patent Application (PPA) with serial number 201811016704, filed on May 3, 2018 and subsequently postdated by 6 Months to Nov. 3, 2018 with the tile, “MECHANICAL EXFOLIATION ROUTE FOR SCALED-UP-SYNTHESIS OF DOPED AND FUNCTIONALIZED GRAPHENE DERIVATIVES”, and the contents of which are included entirely by reference herein. The present application claims the priority of both the PCT applications with the serial number PCT/IN2019/050505 and PCT/IN2019/050814.

### BACKGROUND

### Technical Field

The present invention is generally related to a field of graphene nanotechnology. The present invention is particularly related to a system and method for bulk synthesis of graphene nano-platelets and a plurality of derivatives for a plurality of technological applications. The present invention is more particularly related to a system and method to synthesize graphene and the plurality of derivatives using a mechanical exfoliation technique that is green, simple, cost-effective and scaled-up process. The present invention is especially related to a system and method a synthesis of p- and n- doped graphene nano-platelets and functionalized graphene nano-platelets from graphene ceramic composite through an eco-friendly, cost-effective and scaled-up synthesis route.

### Description of the Related Art

Graphene is a one atomic layer thick carbon sheet comprising a two-dimensional structure. The two-dimensional structure of graphene consists of sp2 hybridized carbon atoms. Graphene has stimulated an extensive interest in a plurality of applications due to its extraordinary properties. Functionalization of the graphene layers with functional groups like —COOH, —CHO, —OH etc. renders various adsorption and conduction properties to these graphene derivatives.

The most common techniques to obtain graphene and a plurality of derivatives are Hummer's method, scotch tape method or chemical vapor deposition method. The drawback with Hummers' Method are chemical impurities due to the use of extremely strong reagents. Further, the Scotch Tape Method has limitation of low yield and chemical impurities that come from the adhesives on the scotch tape. Finally, in Chemical Vapor Deposition (CVD) method although there are no impurities, but the low yield and high cost makes the process unfeasible for bulk scale production. Additionally, the synthesis of graphene and plurality of derivatives by the aforementioned techniques comprises tedious steps subsequently followed by purifications stages.

The most commonly used method for manipulating the properties of graphene is by the incorporation of atoms in the structure of the material or by the addition of some functional groups on the graphene surface. The doped and functionalized graphene derivatives are obtained by a plurality of chemical routes such as chemical vapor deposition, solid state synthesis, solvothermal synthesis and the like.

The chemical method of synthesis illustrate a plurality of disadvantages such as introduction of chemical impurities, low yield of the product, expensive precursors, long processing time and the like. These methods of synthesis comprise a plurality of steps for the synthesis and purification of the final material.

Hence there is a need for a system and method for bulk synthesis of graphene and the plurality of derivatives using a mechanical exfoliation technique that is green, simple, cost-effective and results in a scaled-up yield. Also, there is a need for a system and method for synthesizing graphene and a plurality of derivatives without a need for expensive chemicals and without releasing toxic substances into the atmosphere. Yet there is a need for manipulation in the graphene structure for increasing the technological applications of the graphene material. Still further there is a need for a synthesis route with scaled-up yield, cost-effective technique as well as an eco-friendly approach for the synthesis of doped and functionalized graphene derivatives.

The above shortcomings, disadvantages and problems are addressed herein, which will be understood by studying the following specification.

### OBJECTIVES OF THE EMBODIMENTS

The primary objective of the embodiment herein is to provide a simple and cost-effective system and method for synthesizing graphene nano-platelets by an exfoliation method.

Another objective of the embodiment herein is to provide a technique to synthesize doped and functionalized graphene nano-platelets via exfoliation.

Yet another objective of the embodiment herein is to provide a system and method for exfoliating graphene from graphene ceramic composite.

Yet another objective of the embodiment herein is to provide a system and method for synthesizing graphene nano-platelets in bulk by exfoliating graphene from graphene ceramic composite.

Yet another objective of the embodiment herein is to provide a system and method for exfoliation of graphene from the graphene ceramic composite with a high mechanical shearing process with a range of 500 rpm-10000 rpm and ultra-sonication technique.

Yet another objective of the embodiment herein is to provide a system and method for synthesizing graphene to extract high purity graphene derivatives with reduced chemical impurities and defects as compared to other chemical synthesis routes.

Yet another objective of the embodiment herein is to provide a system and method for synthesizing graphene for forming graphene ceramic composite using ceramics including oxides of aluminum, silicon, zinc, magnesium, calcium, zirconium, etc.

Yet another objective of the embodiment herein is to provide a system and method for synthesizing graphene and a plurality of derivatives by using glucose, fructose, lactose, coal tar, asphalt, recycled plastics, as the source of carbon in the graphene ceramic composite.

Yet another objective of the embodiment herein is to provide a system and method for the exfoliation of graphene ceramic composite in a plurality of solvents/stabilizing agents such as acetone, ethanol, water, iso-propyl alcohol, N-methyl pyrrolidone (NMP), N,N-dimethylformamide (DMF) and dimethyl sulfoxide (DMSO).

Yet another objective of the embodiment herein is to provide a system and method for synthesizing graphene nano-platelets from graphene ceramic composite with controllable sheet thickness of graphene nano-platelets.

Yet another objective of the embodiment herein is to provide a system and method for synthesizing graphene nano-platelets from graphene ceramic composite with controllable the sheet diameter (size).

Yet another objective of the embodiment herein is to provide a method for synthesizing graphene nano-platelets from graphene ceramic composite with controllable crystallinity.

Yet another objective of the embodiment herein is to provide a system and method for synthesizing graphene nano-platelets from graphene ceramic by exfoliating graphene nano-platelets in a mixture with micronized/nanonized ceramic particles.

Yet another objective of the embodiment herein is to provide a system and method for functionalizing the graphene ceramic composite to exfoliate functionalized graphene derivatives.

Yet another objective of the embodiment herein is to synthesize doped graphene ceramic composite.

Yet another objective of the embodiment herein is to synthesize functionalized graphene ceramic composite.

Yet another objective of the embodiment herein is to provide a method of mechanical shearing of doped and functionalized graphene sheets from graphene ceramic composite and ultra-sonication of the sheared sheets to form graphene nano-platelet derivatives.

Yet another objective of the embodiment herein is to provide doped graphene derivatives with desired dopant type and concentration.

Yet another objective of the embodiment herein is to provide a technique to dope the graphene derivatives with p- and n-type dopants.

Yet another objective of the embodiment herein is to provide a process of doping which comprises dopants selected from group 13 elements and group 15 elements.

Yet another objective of the embodiment herein is to provide functionalized graphene derivatives with desired functional groups and concentration.

Yet another objective of the embodiment herein is to provide a process of functionalizing graphene nano-platelets with sulphur, TiO2, EDTA, Fe3O4, MnO2, ethylene oxide and a plurality of organic functional groups selected from hydroxyl, amine, amide, carboxylic, imine, ester and the like.

Yet another objective of the embodiment herein is to provide a method comprising the use of oxides of aluminium, silicon, zinc, magnesium, calcium, zirconium and the like.

Yet another objective of the embodiment herein is to provide a process which comprises of use of carbon sources like sucrose, fructose, lactose, coal tar, asphalt, recycled plastics and the like.

Yet another objective of the embodiment herein is to provide a plurality of solvents/stabilizing agents such as water, acetone, ethanol, N-methyl-2-pyrrolidone (NMP), dimethyl sulfoxide (DMSO), isopropyl alcohol (IPA), dimethyl formamide (DMF) and the like for mechanically exfoliating the doped and functionalized composites.

Yet another objective of the embodiment herein is to provide a shearing process for the exfoliation of the doped and functionalized graphene derivatives from graphene ceramic composite at a rotation speed of 500-4000 rpm with or without simultaneous sonication.

Yet another objective of the embodiment herein is to provide a method for the synthesis of graphene derivatives with controllable dimension and crystallinity.

These and other objects and advantages of the present invention will become readily apparent from the following detailed description taken in conjunction with the accompanying drawings.

### A) SUMMARY OF THE INVENTION

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The other objects and advantages of the present invention will become readily apparent from the following description taken in conjunction with the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

The various embodiments herein provide a method for the scaled-up synthesis of doped and functionalized graphene nano-platelets using a mechanical exfoliation technique. The embodiments of the present invention provide a method for synthesizing doped and functionalized graphene nano-platelets which is both simple and cost-effective.

According to one embodiment herein, a method is provided for synthesizing graphene and a plurality of derivatives through mechanical shearing. The method comprises the steps of synthesizing a ceramic substrate from a ceramic material in particulate form, and wherein the ceramic material is selected from a group consisting of oxides of silicon, aluminum, zirconium, zinc, magnesium, and calcium. Carbon material is deposited on the synthesized ceramic substrate to obtain a graphene ceramic substrate coated with carbonaceous material and wherein the carbon material is selected from a group consisting of glucose, lactose, fructose, coal tar, asphalt, and recycled plastics. The graphene ceramic substrate coated with carbonaceous material is mixed/dissolved in at least one solvent and subjected to mechanical shearing to exfoliate graphene layers from the graphene ceramic substrate coated with carbonaceous material, and wherein the at least one solvent is selected from a group consisting of acetone, ethanol, water, isopropyl alcohol (IPA), N-Methyl-2-pyrrolidone (NMP), dimethylformamide (DMF), and dimethyl sulfoxide (DMSO).

According to one embodiment herein, a system for synthesizing graphene and a plurality of derivatives through a mechanical shearing is disclosed. The system comprises a beaker fitted with a rod and a plurality of blades. The plurality of blades is attached to the rod at one end. Another end of the rod is attached to a power supply through a motor. The beaker comprises a synthesized graphene ceramic composite mixed with at least one solvent, wherein the synthesized graphene ceramic composite is acquired/obtained by synthesizing a ceramic substrate from a ceramic material in particulate form, depositing carbon material on the synthesized ceramic substrate and synthesizing the carbonaceous material coated graphene ceramic substrate, and wherein the ceramic material is selected from a group consisting of oxides of silicon, aluminum, zirconium, zinc, magnesium, and calcium wherein the carbon material is selected from a group consisting of glucose, lactose, fructose, coal tar, asphalt, and recycled plastics.

According to one embodiment herein, the plurality of blades is metallic blades. According to one embodiment herein, the plurality of metallic blades is coupled to a rotor through a cylindrical rod, and wherein the metallic blades are rotated to exfoliate graphene layers from the graphene ceramic substrate through a mechanical shearing process.

According to one embodiment herein, the graphene ceramic substrate coated with carbonaceous material is dissolved in at least one solvent and subjected to a mechanical shearing process toe xfoliate graphene layers from the graphene ceramic substrate coated with carbonaceous material, and wherein the at least one solvent is selected from a group consisting of acetone, ethanol, water, isopropyl alcohol (IPA), N-Methyl-2-pyrrolidone (NMP), dimethylformamide (DMF), and dimethyl sulfoxide (DMSO).

According to one embodiment herein, a method is provided for synthesizing graphene nano-platelets through an exfoliation process.

According to one embodiment herein, a method is provided for synthesizing graphene nano-platelets in bulk quantity by using exfoliation technique, and graphene ceramic composites.

According to one embodiment herein, a method of mechanically shearing the graphene sheets from graphene ceramic composite is provided. The exfoliated sheets are ultra-sonicated for the synthesis of graphene nano-platelets.

According to one embodiment herein, high purity graphene derivatives are obtained by performing the mechanical shearing action/process of graphene ceramic composite. When compared to other chemical methods, in the mechanical shearing process of the graphene ceramic nanocomposites, the amount of chemical used is reduced in the exfoliation process, because the process is a purely a mechanical process, thereby preventing a release of harmful toxic chemicals to the environment.

According to one embodiment herein, a method of graphene ceramic composite synthesis is provided. According to one embodiment herein, the ceramic materials are selected from a group consisting of oxides of aluminum, silicon, zinc, magnesium, calcium, zirconium etc. According to one embodiment herein, the sources of carbon is selected from a group consisting of glucose, fructose, lactose, coal tar, asphalt and recycled plastics. The selection of the materials is configured/customized to form a universally adaptable method.

According to one embodiment herein, a method to exfoliate graphene from graphene ceramic composite is provided. The exfoliation of graphene ceramic composite is performed in the presence of solvents/stabilizing agents, and wherein the solvents/stabilizing agents are selected from a group consisting of acetone, ethanol, water, isopropyl alcohol (IPA), N-Methyl-2-pyrrolidone (NMP), dimethylformamide (DMF) and dimethyl sulfoxide (DMSO).

According to one embodiment herein, a method for the controlled synthesis of graphene nano-platelets is provided. According to one embodiment herein, a sheet thickness, diameter (size) and crystallinity of the graphene nano-platelets are controlled based on requirement/usage application.

According to one embodiment herein, a mechanical exfoliation method is utilized for exfoliating the graphene nano-platelets from the graphene ceramic composite. The graphene ceramic composite material is synthesized using ceramic materials such as oxides of silicon, aluminum, silicon, zinc, magnesium, calcium and zirconium, in particulate form. The particulate ceramic material is washed and annealed for activation and removal of contaminants from the surface. A plurality of carbon precursors selected from a group consisting of glucose, fructose, lactose, coal tar, asphalt and recycled plastics are coated on the particulate ceramic materials using water as a solvent. The coated ceramic materials are then carbonized in air at a temperature range of 200 to 400° C. The coated ceramic particulate materials are segregated and are annealed under inert atmosphere condition at a temperature range of 600 to 950° C., thereby resulting in the formation of graphitic carbon (graphene) on the ceramic particles followed by its functionalization/partial oxidation, and wherein the inert atmosphere comprises an inert gas selected from a group consisting of argon, nitrogen, etc. The graphene layers are exfoliated from the ceramic particles by performing a mechanical shearing process of a dispersion solution, and wherein the dispersion solution comprises graphene ceramic composite dissolved/dispersed in a plurality of solvents, and wherein the plurality of solvents is selected from a group consisting like acetone, ethanol, water, isopropyl alcohol (IPA), N-Methyl-2-pyrrolidone (NMP). dimethylformamide (DMF) and dimethyl sulfoxide (DMSO). The exfoliated graphene layers are subjected to ultra-sonication followed by centrifugation resulting in a formation of graphene nano-platelets. The obtained residual graphene ceramic composite is reused for carbonization and further exfoliation.

According to one embodiment herein, a process is provided to synthesize functionalized graphene ceramic composite and exfoliate the functionalized graphene derivatives or the graphene ceramic composite to obtain the graphene nano-platelets.

According to one embodiment herein, the mechanical shearing process involves the ceramic particles coated with carbonaceous materials and dispersed/dissolved in a solvent (such as ethanol, acetone or IPA)is placed in a beaker and is subjected to high rate stirring using mechanical means such as a metallic blade rotated at a speed of 500-10000 rpm. This rotation of blades generates plastic strain in the material which causes graphene and the graphene derivatives to chisel/separate out from the ceramic-graphene composite, to extract/obtain graphene and graphene derivatives. Further, ultrasonication is employed to ensure exfoliation of graphene layers.

According to one embodiment herein, a graphene ceramic based composite material is provided, which is further exfoliated mechanically to produce doped and functionalized graphene derivatives.

According to one embodiment herein, doped graphene ceramic based composite is used for mechanical exfoliation of graphene derivatives from the composite material. The mechanically sheared graphene derivatives are further ultra-sonicated to form doped graphene nano-platelets.

According to one embodiment herein. functionalized graphene based ceramic composite is mechanically exfoliated to form functionalized graphene derivatives. The mechanically sheared functional graphene derivatives are ultra-sonicated to form functional graphene nano-platelets.

According to one embodiment herein, a process for the mechanical shearing of graphene derivatives in a sonicator bath is provided for the synthesis of doped and functionalized graphene nano-platelets.

According to one embodiment herein, a method for the synthesis of doped graphene composite and doped graphene nano-platelets with control over the final dopant type and concentration is provided. The type of dopant to be incorporated as well as the concentration of the dopant is tunable or adjusted according to the need of the application.

According to one embodiment herein, a process for the synthesis of graphene ceramic composite and graphene nano-platelets doped with p- and n-type materials is provided. The p-type doping is obtained by doping with group 13 elements while n-type doping of the graphene ceramic composite is obtained by group 15 elements of the periodic table.

According to one embodiment herein, a process for the synthesis of functionalized graphene ceramic based composite and functionalized graphene nano-platelets is provided. The type of functional moieties and concentration on the graphene nano-platelets surface are tunable according to the need of the application.

According to one embodiment herein, a process for the synthesis of functionalized graphene ceramic based composite and functionalized graphene nano-platelets is provided. The process utilizes oxides of aluminium, silicon, zinc, magnesium, calcium, zirconium and the like as the ceramic source. The process further utilizes sucrose, fructose, lactose, coal tar, asphalt, recycled plastics and the like as the source of carbon for the synthesis of graphene ceramic composite.

According to one embodiment herein, a plurality of solvents/stabilizers are provided for the synthesis of doped graphene derivatives such as water, acetone, ethanol, NMP, DMSO, IPA, DMF and the like.

According to one embodiment herein, a method of synthesizing doped graphene ceramic composite is provided which controls the size of the graphene nano-platelets and the crystallinity of the graphene nano-platelets by use of appropriate solvents/stabilizing agents, ceramic and carbon sources.

According to one embodiment herein, a method to exfoliate doped graphene sheets from doped graphene ceramic composite is provided. The doping in graphene ceramic composites is performed by incorporation of the precursor comprising dopant materials in the reaction mixture comprising of carbon sources such as sucrose, fructose, lactose, coal tar, asphalt, recycled plastics and the like. The ceramic material such as oxides of aluminium, silicon, zinc, magnesium, calcium, zirconium and the like. The carbonization of the coated material on the ceramic surface is carried out in a temperature range of 200 to 400° C. The graphitization of the carbonized composite is carried out under inert atmospheric temperature conditions maintained in a range of 600-950°. The step results in the formation of doped graphitic carbon on ceramic particles.

According to one embodiment herein, a method to exfoliate functionalized graphene sheets from functionalized graphene based ceramic composite is provided. The functionalization of the graphene ceramic composite is obtained by the post-treatment of the graphitized ceramic based composite. The post-treatment comprises the direct addition of the functional moiety in an aqueous solution to the graphene ceramic composite. The time period of functionalization of the reaction varies between the range of 8-15 hours and is carried out in predetermined temperature and pressure conditions.

According to one embodiment herein, the doped and functionalized composites are mechanically exfoliated in solvents like water, ethanol, acetone, NMP, IPA, DMSO, DMF and the like to obtain doped and functionalized graphene sheets respectively. The doped and functionalized graphene derivative obtained are further ultra-sonicated and centrifuged resulting in the formation of doped and functionalized graphene nano-platelets, respectively. The residual ceramic material post exfoliation is reused for carbonization and further exfoliation.

According to one embodiment herein, a method of synthesizing exfoliated doped graphene nano-platelets from doped graphene ceramic composite comprises the following steps. The particulate ceramic material is washed and annealed for surface activation and removal of contaminants. Annealing of the particulate ceramic material is performed at a temperature of 200° C. The annealed particulate ceramic material is coated and carbonized with carbon source/precursors. The carbon source is selected from a group consisting of sucrose, fructose, lactose, coal tar, asphalt and recycled plastic. The annealed particulate ceramic material is functionalized in presence of graphene to obtain graphene ceramic composite. The graphene ceramic composite are subjected to graphitization. The functionalization comprises incorporating dopant in the graphene ceramic composite. Carbonization of coated ceramic material is performed at a temperature range of 200-400° C. The graphitization is performed at a temperature range of 600-950° C. under atmospheric temperature. The graphene ceramic composite is doped with dopant precursor. The doped graphene ceramic composite is exfoliated by ultra-sonication and centrifugation to obtain graphene nano-platelets. The particulate ceramic material is used again for the synthesis of graphene nano-platelets.

According to one embodiment herein, the graphene ceramic composite is synthesized by coating carbon precursor on the ceramic material. The carbon precursor and the ceramic material is subjected to carbonization and graphitization.

According to one embodiment herein, the step of doping the graphene ceramic composite with dopant precursor composition comprises the following steps. The graphene ceramic composite is treated with a dopant precursor solution with the concentration of the dopant precursor solution in a range of 3% w/w-10% w/w with respect to graphene ceramic composite. The dopant precursor selected from a group consisting of boron, nitrogen and phosphorus. The dopant precursor solution is synthesized in solvents selected from a group consisting of hexamethyene-tetra amine and boric acid.

According to one embodiment herein, the step of functionalizing graphene ceramic composite comprises the following steps. The graphene ceramic composite is treated with acids. The acids are selected from a group consisting of H2SO4, HNO3, NaOH and KOH. The acids create a plurality of active site on the graphene ceramic composite surface. The graphene ceramic composite comprising a plurality of active sites is treated with precursors/inorganic groups. The precursors are selected from a group consisting of EDTA, thiourea, Fe3O4, MnO2. The concentration of precursor is in a range of 0.5%w/w-5%w/w with respect to graphene ceramic composite. The functionalized graphene ceramic composite is exfoliated to obtain functionalized graphene nanoplatelets.

According to one embodiment herein, the step of exfoliating the doped graphene ceramic composite by ultra-sonication and centrifugation to obtain graphene nano-platelets comprises the following steps. The functionalized graphene ceramic composite is dispersed in solvent/stabilizing agent in a metal beaker. The graphene ceramic composite is stirred in solvent/stabilizing agent in the beaker by a mechanical stirrer at 4000-5000 rpm. The mechanical stirrer shears the graphene ceramic composite particles. The solvent/stabilizing agent is collected in a beaker. The collected solvent/stabilizing agent is ultrasonicated for 3-4 hours. The ultrasonicated solvent/stabilizing agent is centrifuged to collect a plurality of layers of graphene nanoplatelets and separated ceramic composite. The layer of ceramic composite of separated from graphene nanoplatelets. Mechanical shearing exfoliates graphene sheets from ceramic composite.

According to one embodiment herein, the solvent/stabilizing agent is selected from a group consisting of water, acetone, ethanol, N-methyl-2-pyrrolidone (NMP), dimethyl sulfoxide (DMSO), isopropyl alcohol (IPA), dimethyl formamide (DMF).

According to one embodiment herein, the ceramic material is selected from a group consisting of oxides of aluminum, oxides of silicon, oxides of zinc, oxides of magnesium, oxides of calcium and oxides of zirconium.

According to one embodiment herein, the ceramic material is a substrate on which graphene is grown.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

### BRIEF DESCRIPTION OF THE DRAWINGS

The other objects, features and advantages will occur to those skilled in the art from the following description of the preferred embodiment and the accompanying drawings in which:

FIG. 1 illustrates a flow chart explaining a method of exfoliating the graphene nano-platelets from graphene ceramic composite, according to one embodiment of the present invention.

FIG. 2 illustrates a block diagram of a system used for the exfoliation of the graphene nano-platelets from graphene ceramic composite, according to one embodiment of the present invention.

FIG. 3 illustrates a chart indicating a comparison analysis of Fourier transform infrared (FTIR) spectra of silica and silica-based graphene ceramic composite (GCC) before and after a chemical treatment performed to introduce functional groups, according to one embodiment of the present invention.

FIG. 4 illustrates a chart indicating a comparison analysis of X-ray photoelectron spectroscopy (XPS) spectra of graphene nanoplatelets obtained from mechanical shearing of silica-based graphene ceramic composite (GCC) before and after a chemical treatment with H₂SO₄, according to one embodiment of the present invention.

FIG. 5 illustrates a deconvoluted C1s peak of graphene nanoplatelets obtained from silica-based graphene ceramic composite (GCC) after a chemical treatment with H₂SO₄, according to one embodiment of the present invention.

FIG. 6 illustrates deconvoluted O1s peak of graphene nanoplatelets obtained from silica based graphene ceramic composite (GCC) after a chemical treatment with H₂SO₄, according to one embodiment of the present invention.

FIG. 7 is a flow chart illustrating a method for the exfoliation of doped graphene nano-platelets from doped graphene ceramic composite, according to one embodiment of the present invention.

FIG. 8 is a flow chart illustrating a process for the exfoliation of functionalized graphene nano-platelets from functionalized graphene ceramic composite, according to one embodiment of the present invention.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that other changes may be made without departing from the scope of the embodiments. The following detailed description is therefore not to be taken in a limiting sense.

The various embodiments herein provide a method for the scaled-up synthesis of doped and functionalized graphene nano-platelets using a mechanical exfoliation technique. The embodiments of the present invention provide a method for synthesizing doped and functionalized graphene nano-platelets which is both simple and cost-effective.

According to one embodiment herein, a method is provided for synthesizing graphene and a plurality of derivatives through mechanical shearing. The method comprises the steps of synthesizing a ceramic substrate from a ceramic material in particulate form, and wherein the ceramic material is selected from a group consisting of oxides of silicon, aluminum, zirconium, zinc, magnesium, and calcium. Carbon material is deposited on the synthesized ceramic substrate to obtain a graphene ceramic substrate coated with carbonaceous material and wherein the carbon material is selected from a group consisting of glucose, lactose, fructose, coal tar, asphalt, and recycled plastics. The graphene ceramic substrate coated with carbonaceous material is mixedldissolved in at least one solvent and subjected to mechanical shearing to exfoliate graphene layers from the graphene ceramic substrate coated with carbonaceous material, and wherein the at least one solvent is selected from a group consisting of acetone, ethanol, water, isopropyl alcohol (IPA), N-Methyl-2-pyrrolidone (NMP), dimethylformamide (DMF), and dimethyl sulfoxide (DMSO).

According to one embodiment herein, a system for synthesizing graphene and a plurality of derivatives through a mechanical shearing is disclosed. The system comprises a beaker fitted with a rod and a plurality of blades. The plurality of blades is attached to the rod at one end. Another end of the rod is attached to a power supply through a motor. The beaker comprises a synthesized graphene ceramic composite mixed with at least one solvent, wherein the synthesized graphene ceramic composite is acquired/obtained by synthesizing a ceramic substrate from a ceramic material in particulate form, depositing carbon material on the synthesized ceramic substrate and synthesizing the carbonaceous material coated graphene ceramic substrate, and wherein the ceramic material is selected from a group consisting of oxides of silicon, aluminum, zirconium, zinc, magnesium, and calcium wherein the carbon material is selected from a group consisting of glucose, lactose, fructose, coal tar, asphalt, and recycled plastics.

According to one embodiment herein, the plurality of blades is metallic blades. According to one embodiment herein, the plurality of metallic blades is coupled to a rotor through a cylindrical rod, and wherein the metallic blades are rotated to exfoliate graphene layers from the graphene ceramic substrate through a mechanical shearing process.

According to one embodiment herein, the graphene ceramic substrate coated with carbonaceous material is dissolved in at least one solvent and subjected to a mechanical shearing process to exfoliate graphene layers from the graphene ceramic substrate coated with carbonaceous material, and wherein the at least one solvent is selected from a group consisting of acetone, ethanol, water, isopropyl alcohol (IPA), N-Methyl-2-pyrrolidone (NMP), dimethylformamide (DMF), and dimethyl sulfoxide (DMSO).

According to one embodiment herein, a method is provided for synthesizing graphene nano-platelets through an exfoliation process.

According to one embodiment herein, a method is provided for synthesizing graphene nano-platelets in bulk quantity by using exfoliation technique, and graphene ceramic composites.

According to one embodiment herein, a method of mechanically shearing the graphene sheets from graphene ceramic composite is provided. The exfoliated sheets are ultra-sonicated for the synthesis of graphene nano-platelets.

According to one embodiment herein, high purity graphene derivatives are obtained by performing the mechanical shearing action/process of graphene ceramic composite. When compared to other chemical methods, in the mechanical shearing process of the graphene ceramic nanocomposites, the amount of chemical used is reduced in the exfoliation process, since the exfoliation process is a purely mechanical process, thereby preventing a release of harmful toxic chemicals to the environment.

According to one embodiment herein, a method of graphene ceramic composite synthesis is provided. According to one embodiment herein, the ceramic materials are selected from a group consisting of oxides of aluminum, silicon, zinc, magnesium, calcium, zirconium etc. According to one embodiment herein, the sources of carbon is selected from a group consisting of glucose, fructose, lactose, coal tar, asphalt and recycled plastics. The selection of the materials is configured/customized to form a universally adaptable method.

According to one embodiment herein, a method to exfoliate graphene from graphene ceramic composite is provided. The exfoliation of graphene ceramic composite is performed in the presence of solvents/stabilizing agents, and wherein the solvents/stabilizing agents are selected from a group consisting of acetone, ethanol, water, isopropyl alcohol (IPA), N-Methyl-2-pyrrolidone (NMP), dimethylformamide (DMF) and dimethyl sulfoxide (DMSO).

According to one embodiment herein, a method for the controlled synthesis of graphene nano-platelets is provided. According to one embodiment herein, a sheet thickness, diameter (size) and crystallinity of the graphene nano-platelets are controlled based on requirement/usage application.

According to one embodiment herein, a mechanical exfoliation method is utilized for exfoliating the graphene nano-platelets from the graphene ceramic composite. The graphene ceramic composite material is synthesized using ceramic materials such as oxides of silicon, aluminum, silicon, zinc, magnesium, calcium and zirconium, in particulate form. The particulate ceramic material is washed and annealed for activation and removal of contaminants from the surface. A plurality of carbon precursors selected from a group consisting of glucose, fructose, lactose, coal tar, asphalt and recycled plastics are coated on the particulate ceramic materials using water as a solvent. The coated ceramic materials are then carbonized in air at a temperature range of 200 to 400′C. The coated ceramic particulate materials are segregated and are annealed under inert atmosphere condition, wherein the inert atmosphere comprises an inert gas selected from a group consisting of argon, nitrogen, etc., at a temperature range of 600 to 950′C, thereby resulting in the formation of graphitic carbon (graphene) on the ceramic particles followed by its functionalization/partial oxidation, and The graphene layers are exfoliated from the ceramic particles by performing a mechanical shearing process of a dispersion solution, and wherein the dispersion solution comprises graphene ceramic composite dissolved/dispersed in a plurality of solvents, and wherein the plurality of solvents is selected from a group consisting like acetone, ethanol, water, isopropyl alcohol (IPA), N-Methyl-2-pyrrolidone (NMP). dimethylformamide (DMF) and dimethyl sulfoxide (DMSO). The exfoliated graphene layers are subjected to ultra-sonication followed by centrifugation resulting in a formation of graphene nano-platelets. The obtained residual graphene ceramic composite is reused for carbonization and further exfoliation.

According to one embodiment herein, a process is provided to synthesize functionalized graphene ceramic composite and exfoliate the functionalized graphene derivatives or the graphene ceramic composite to obtain the graphene nano-platelets.

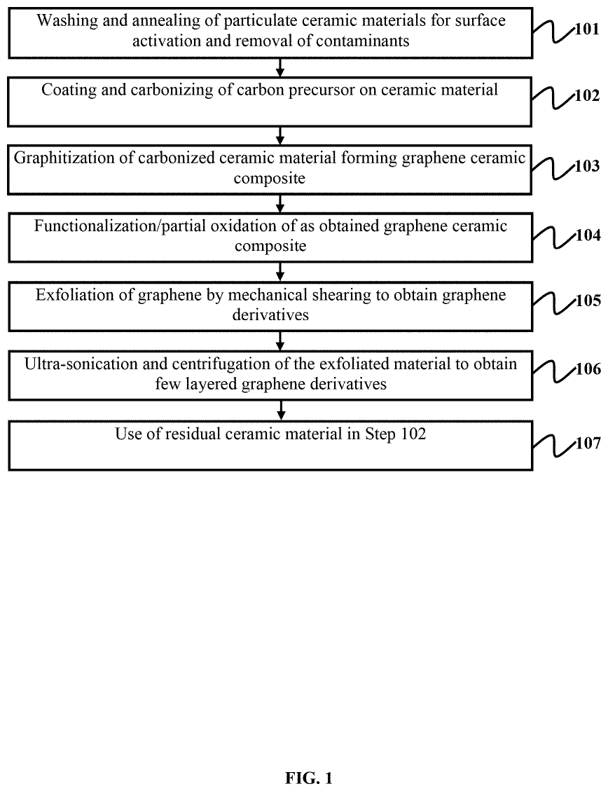

FIG. 1 illustrates a flow chart explaining a method of exfoliating the graphene nano-platelets from the graphene ceramic composite, according to one embodiment of the present invention. The particulate ceramic materials are washed and annealed for surface activation and removal of contaminants (step 101). The carbon precursor is coated and carbonized on washed and annealed ceramic material (step 102). The carbonized ceramic material is subjected for graphitization to obtain graphene ceramic composite (step 103). The graphene ceramic composite is functionalized/partially oxidized to obtain graphene ceramic composite (step 104). The graphene ceramic composite is exfoliated by mechanical shearing to obtain graphene derivatives (step 105). The exfoliated material is ultrasonicated and centrifuged to obtain layered graphene derivatives (step 106). The residual graphene ceramic composite obtained after mechanical shearing is reused for carbonization and exfoliation (step 107).

Graphene Ceramic Composite (GCC) basically comprises a ceramic particle deposited with graphene on the surface. The GCC coated with graphene is subjected to a mechanical shearing process to remove the graphene layer from top of GCC. When GCC is first treated with sulfuric acid, the functional groups are formed on the surface of graphene. This functionalized graphene is basically termed as “uaphene derivative”.

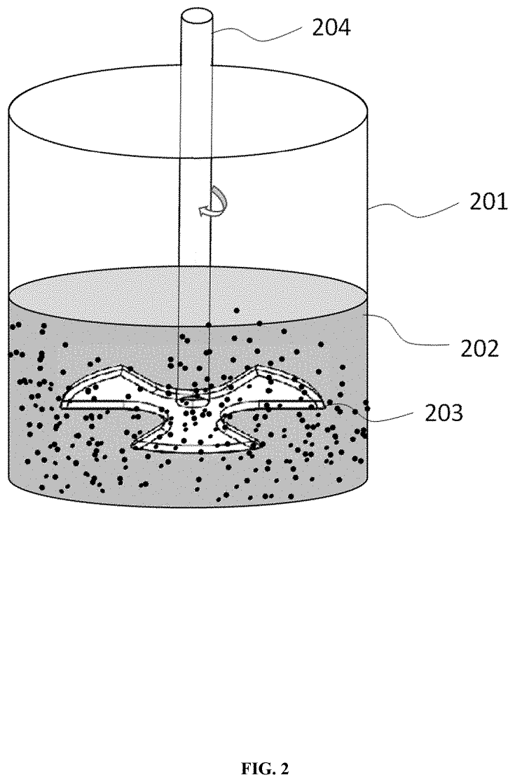

FIG. 2 illustrates a block diagram of a system used in the exfoliation of the graphene nano-platelets from the graphene ceramic composite, according to one embodiment of the present invention. The system comprises a beaker 201, containing a solvent dispersed/dissolved with graphene ceramic composite 202, metal blades 203, and cylindrical rod 204. The beaker 201 comprises a solvent dispersed with graphene ceramic composite 202 from which graphene is exfoliated using a metal blade 203 attached to a rotor through a cylindrical rod 204 which is operated by an external power supply.

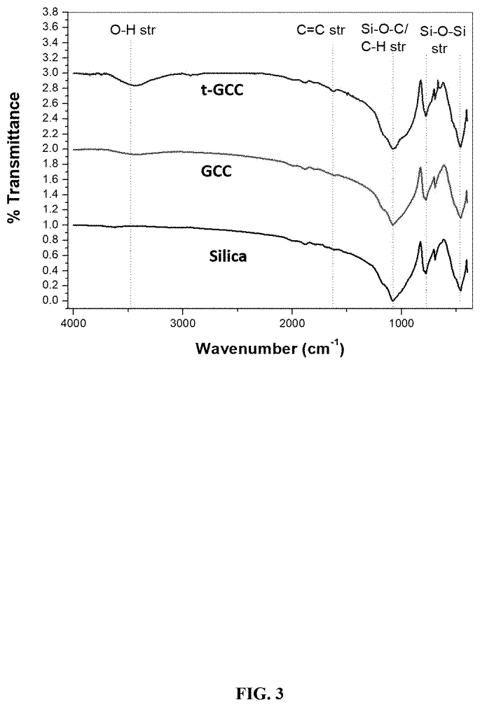

FIG. 3 illustrates a comparative analysis of the Fourier transform infrared (FTIR) spectra of silica and silica-based graphene ceramic composite (GCC) before and after a chemical treatment to introduce functional groups, according to one embodiment of the present invention. The chemical treatment of silica based GCC is carried by transferring the silica based GCC to concentrated H₂SO₄ solution. The solution comprising the silica based. GCC is stirred for 15-75 minutes. The stirred solution is washed for a plurality of times to remove an excess acid and finally dried at 80-200° C. for 1-3 hours. The chemically treated GCC (t-GCC), thus obtained, has a prominent absorption peak at ˜3450 cm⁻¹ which corresponds to introduction of oxygen on graphene surface.

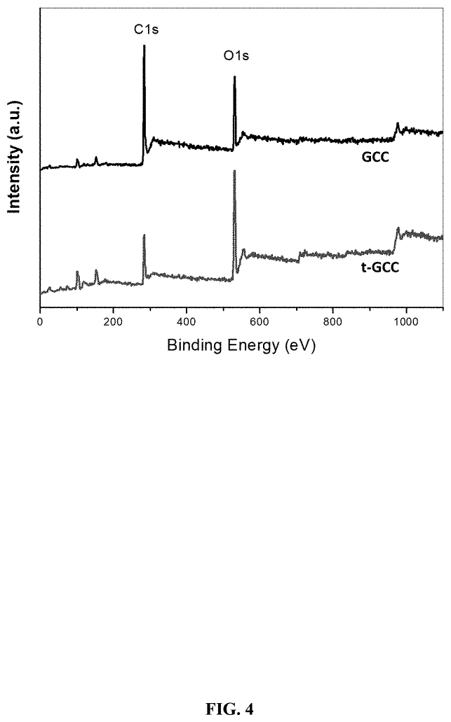

FIG. 4 illustrates a comparative analysis of X-ray photoelectron spectroscopy (XPS) spectra of graphene nanoplatelets obtained from mechanical shearing of silica based graphene ceramic composite (GCC) before and after a chemical treatment with H₂SO₄, according to one embodiment of the present invention. This chemical treatment results in the increase of atomic percentage of oxygen from 36.55% to 56.55% in the resultant graphene nanoplatelets.

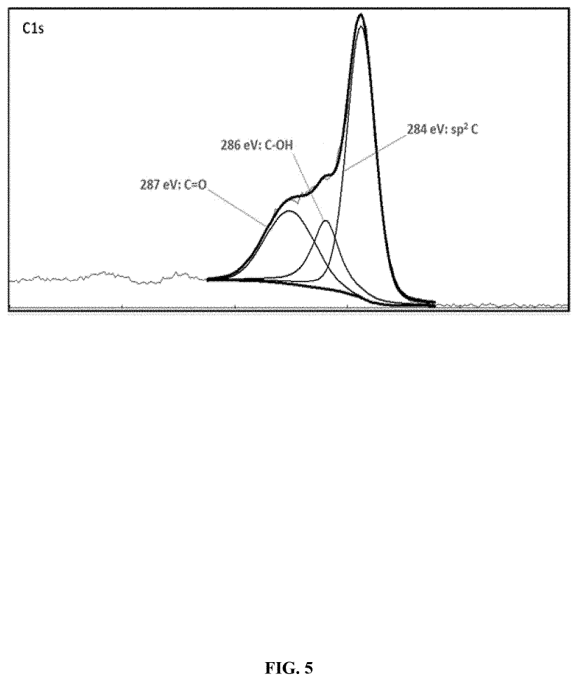

FIG. 5 illustrates the deconvoluted C1s peak of graphene nanoplatelets obtained from silica based graphene ceramic composite (GCC) after chemically treating it with H₂SO₄, according to one embodiment of the present invention.

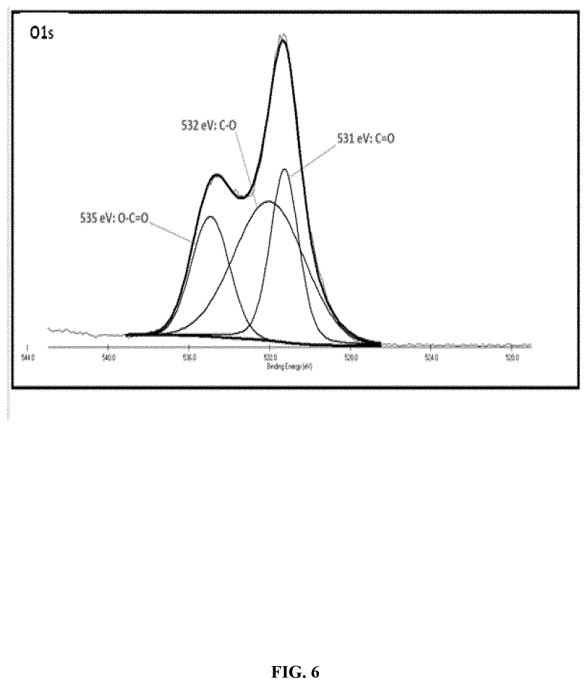

FIG. 6 illustrates the deconvoluted O1s peak of graphene nanoplatelets obtained from silica-based graphene ceramic composite (GCC) after chemically treating it with H₂SO₄, according to one embodiment of the present invention. The maximum content is found to be of C—O bond (49.5%).

The embodiments herein provide a simple and cost-effective method for synthesizing graphene nano-platelets by an exfoliation method.

The embodiments herein provide a method of exfoliating graphene from graphene ceramic composite.

The embodiments herein provide a method for synthesizing graphene nano-platelets in bulk by exfoliating graphene from graphene ceramic composite.

The embodiments herein provide a method comprising high mechanical shearing ranging from 500 rpm and 10000 rpm and ultra-sonication for exfoliation of graphene from the graphene ceramic composite.

The embodiments herein provide a high purity graphene derivative with reduced chemical impurities and defects as compared to other chemical synthesis routes.

The embodiments herein provide a method comprising the use of ceramics including oxides of aluminum, silicon, zinc, magnesium, calcium, zirconium, etc. for formation of graphene composite.

The embodiments herein provide a method for synthesizing graphene and a plurality of derivatives comprising the use of glucose, fructose, lactose, coal tar, asphalt, recycled plastics, and the like as the source of carbon in the graphene ceramic composite.

The embodiments herein provide a exfoliation of graphene ceramic composite in a plurality of solvents/stabilizing agents such as acetone, ethanol, water, isopropyl alcohol, N-methyl pyrrolidone (NMP), N,N-dimethylformamide (DMF) and dimethyl sulfoxide (DMSO).

The embodiments herein provide a method for synthesizing graphene nano-platelets from graphene ceramic composite with controllable sheet thickness of graphene nano-platelets.The embodiments herein provide a method for synthesizing graphene nano-platelets from graphene ceramic composite with controllable sheet diameter (size).

The embodiments herein provide a method for synthesizing graphene nano-platelets from graphene ceramic composite with controllable crystallinity.

The embodiments herein provide a method for synthesizing graphene nano-platelets from graphene ceramic composite, wherein graphene nano-platelets are exfoliated in a mixture with micronized/nanonized ceramic particles.

The embodiments herein provide a process for functionalizing the graphene ceramic composite to exfoliate functionalized graphene derivatives.

According to one embodiment herein, a method of synthesizing exfoliated doped graphene nano-platelets from doped graphene ceramic composite comprises the following steps. The particulate ceramic material is washed and annealed for surface activation and removal of contaminants. Annealing of the particulate ceramic material is performed at a temperature of 200° C. The annealed particulate ceramic material is coated and carbonized with carbon source/precursors. The carbon source is selected from a group consisting of sucrose, fructose, lactose, coal tar, asphalt and recycled plastic. The annealed particulate ceramic material is functionalized in presence of graphene to obtain graphene ceramic composite. The graphene ceramic composite are subjected to graphitization. The functionalization comprises incorporating dopant in the graphene ceramic composite. Carbonization of coated ceramic material is performed at a temperature range of 200-400° C. The graphitization is performed at a temperature range of 600-950° C. under atmospheric temperature. The graphene ceramic composite is doped with dopant precursor. The doped graphene ceramic composite is exfoliated by ultra-sonication and centrifugation to obtain graphene nano-platelets. The particulate ceramic material is used again for the synthesis of graphene nano-platelets.

According to one embodiment herein, the graphene ceramic composite is synthesized by coating carbon precursor on the ceramic material. The carbon precursor and the ceramic material is subjected to carbonaization and graphitization.

According to one embodiment herein, the step of doping the graphene ceramic composite with dopant precursor composition comprises the following steps. The graphene ceramic composite is treated with a dopant precursor solution with the concentration of the dopant precursor solution in a range of 3% w/w-10% w/w with respect to graphene ceramic composite. The dopant precursor selected from a group consisting of boron, nitrogen and phosphorus. The dopant precursor solution is synthesized in solvents selected from a group consisting of hexamethyene-tetra amine and boric acid.

According to one embodiment herein, the step of functionalizing graphene ceramic composite comprises the following steps. The graphene ceramic composite is treated with acids. The acids are selected from a group consisting of H2SO4, HNO3, NaOH and KOH. The acids create a plurality of active site on the graphene ceramic composite surface. The graphene ceramic composite comprising a plurality of active sites is treated with precursors/inorganic groups. The precursors are selected from a group consisting of EDTA, thiourea, Fe3O4, MnO2. The concentration of precursor is in a range of 0.5% w/w-5% w/w with respect to graphene ceramic composite. The functionalized graphene ceramic composite is exfoliated to obtain functionalized graphene nanoplatelets.

According to one embodiment herein, the step of exfoliating the doped graphene ceramic composite by ultra-sonication and centrifugation to obtain graphene nano-platelets comprises the following steps. The functionalized graphene ceramic composite is dispersed in solvent/stabilizing agent in a metal beaker. The graphene ceramic composite is stirred in solvent/stabilizing agent in the beaker by a mechanical stirrer at 4000-5000 rpm. The mechanical stirrer shears the graphene ceramic composite particles. The solvent/stabilizing agent is collected in a beaker. The collected solvent/stabilizing agent is ultrasonicated for 3-4 hours. The ultrasonicated solvent/stabilizing agent is centrifuged to collect a plurality of layers of graphene nanoplatelets and separated ceramic composite. The layer of ceramic composite of separated from graphene nanoplatelets. Mechanical shearing exfoliates graphene sheets from ceramic composite.

According to one embodiment herein, the solvent/stabilizing agent is selected from a group consisting of water, acetone, ethanol, N-methyl-2-pyrrolidone (NMP), dimethyl sulfoxide (DMSO), isopropyl alcohol (IPA), dimethyl formamide (DMF).

According to one embodiment herein, the ceramic material is selected from a group consisting of oxides of aluminum, oxides of silicon, oxides of zinc, oxides of magnesium, oxides of calcium and oxides of zirconium.

According to one embodiment herein, the ceramic material is a substrate on which graphene is grown.

According to one embodiment herein, a mechanical shearing method is provided for obtaining doped graphene sheets from graphene ceramic composite. The exfoliated graphene sheets are ultra-sonicated to obtain doped graphene nano-platelets.

According to one embodiment herein, the mechanical shearing setup is coupled with simultaneous ultra-sonication to obtain doped graphene nano-platelets.

According to one embodiment herein, a method is provided for the synthesis of doped graphene derivatives. The doping of the graphene ceramic composite is a regulated process, where the type and concentration of the dopant used is manipulated or tweaked according to the need.

According to one embodiment herein, p-type and n-type doping in graphene ceramic composite is provided. The p-type and n-type doping in the graphene ceramic composite is obtained by employing elements from the group 13 element and group 15 element of the periodic table respectively.

According to one embodiment herein, a mechanical exfoliation route is provided for obtaining functionalized graphene sheets from graphene ceramic composite. The functionalized graphene sheets exfoliated are further ultra-sonicated to obtain functionalized graphene nano-platelets.

According to one embodiment herein, the graphene ceramic based composite is functionalized by various organic groups like hydroxyl, amine, amide, carboxylic, imine and ester. The graphene ceramic based composite is functionalized by a plurality of inorganic groups such as sulphur, TiO2, EDTA, Fe3O4, MnO2, ethylene oxide and the like.

According to one embodiment herein, a mechanical shearing process of the functionalized graphene based composite is provided with simultaneous sonication of the exfoliation setup.

According to one embodiment herein, a process involving the synthesis of doped graphene derivatives utilizes oxides of aluminium, silicon, zinc, magnesium, calcium, zirconium and the like as the ceramic source. The process involving the synthesis of doped graphene derivatives utilizes sucrose, fructose, lactose, coal tar, asphalt, recycled plastics and the like as the source of carbon.

According to one embodiment herein, a method of exfoliating graphene derivatives sheets from ceramic composite is provided. The exfoliation process is carried out in solvents like water, acetone, ethanol, NMP, IPA, DMSO, DMF and the like. These solvents also function as stabilizers for the synthesized doped and functionalized graphene nano-platelets.

According to one embodiment herein, a route is provided for the synthesis of doped and functionalized graphene nano-platelets to attain control over the size and crystallinity of the final graphene derivatives.

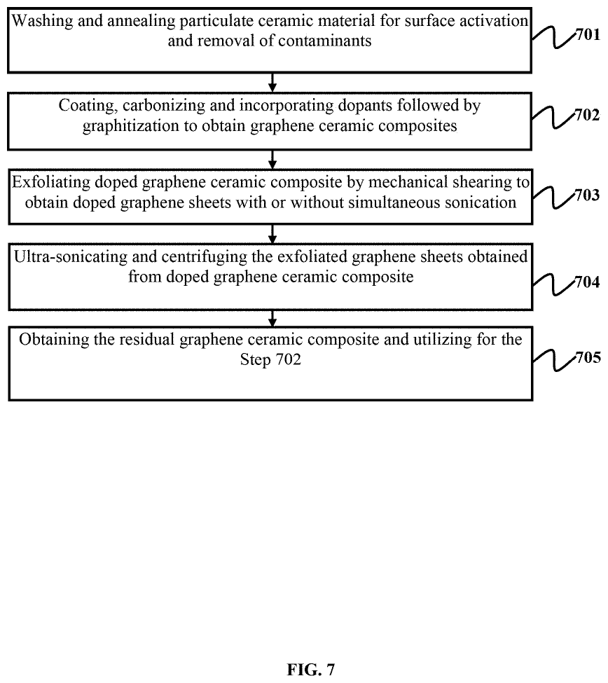

FIG. 7 is a flow chart illustrating a method for the exfoliation of doped graphene nano-platelets from doped graphene ceramic composite, according to one embodiment of the present invention. The particulate ceramic material is subjected to washing and annealing for surface activation and removal of contaminants (701). The graphene ceramic composites are obtained by coating, carbonization and dopant incorporation followed by graphitization (702). The doped graphene ceramic composite are subjected to exfoliation with or without simultaneous ultra-sonication for obtaining doped graphene sheets (703). The exfoliated graphene sheets obtained from doped graphene ceramic composite are subjected to ultra-sonication and centrifugation (704). The ceramic residue obtained after exfoliation is reused in Step 2 (705).

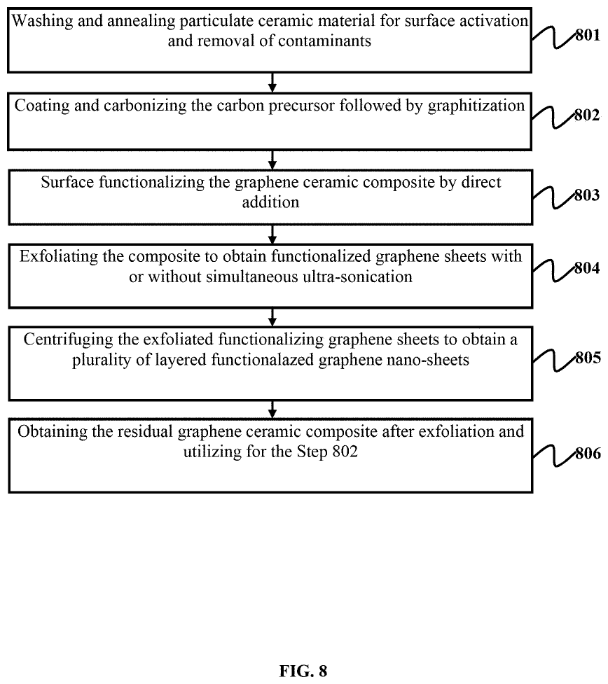

FIG. 8 is a flow chart illustrating a process for the exfoliation of functionalized graphene nano-platelets from functionalized graphene ceramic composite, according to one embodiment of the present invention. Washing and annealing the ceramic material for the surface activation and removal of contaminants (801). Coating and carbonizing the carbon precursor, followed by graphitization (802). Surface functionalization of the graphene ceramic composite by direct addition (803). Exfoliating the composite to obtain functionalized graphene sheets with or without simultaneous ultra-sonication (804). Centrifuging the exfoliated functionalizing graphene sheets to obtain a plurality of layered functionalized graphene nano-sheets (805). The residual graphene ceramic composite is obtained after exfoliation and utilized in step 202 (806).

According to one embodiment herein, following are the steps involved in the synthesis of doped graphene nano-platelets from doped ceramic composite are provided. The doped graphene ceramic composite is obtained by performing carbonization and graphitization of the reaction mixture comprising of dopant precursors, carbon sources and metal oxides. The dopant precursors are selected from group 13 elements and group 15 elements of the periodic table. The carbon sources are selected from a group consisting of sucrose, fructose, lactose, coal tar, asphalt, recycled plastics and the like. The metal oxides are selected from a group consisting of aluminium, silicon, zinc, magnesium, calcium, zirconium and the like. as the ceramic material. The removal of contaminant and surface activation of the particulate ceramic material is performed by annealing at 200° C. (Step I). The annealed ceramic particulates undergo carbonization and graphitization in the presence of the aforementioned dopant and carbon precursor to obtain doped graphene ceramic composite (Step 2). Mechanical shearing of the doped graphene layers from the dispersion containing doped graphene ceramic composite in organic solvents like acetone, ethanol, water, IPA, DMSO, NMP, DMF and the like. (Step 3). The exfoliated doped graphene sheets are ultra-sonicated and centrifuged to obtain doped graphene nano-platelets. The residual ceramic particulates are reused for carbonization and graphitization mentioned above in step 2.

According to one embodiment herein, route followed for the synthesis of functionalized graphene ceramic composite and functionalized graphene nano-platelets is provided. The graphene ceramic composite is synthesized by the coating of the carbon precursor on the ceramic material followed by its carbonization and graphitization. The functionalization of the synthesized graphene ceramic composite is obtained by the direct reaction of the precursors with the graphene composite in solution phase.

According to one embodiment herein, an exfoliation system for the synthesis of graphene derivatives is provided. The method utilizes a system comprising metal blades which provide the required energy for shearing of doped or functionalized graphene sheets from graphene ceramic composite, at a rotation speed of 500-4000 rpm. The mechanical shearing of the composite is done both in the presence or absence of simultaneous ultra-sonication. The mechanically sheared graphene derivatives' sheets are ultra-sonicated for duration of 2-4 hours and centrifuged to obtain doped or functionalized graphene nano-platelets. The ceramic residue after mechanical exfoliation is reused in further carbonization and graphitization steps.

According to one embodiment herein, the current methods for the synthesis of graphene and its derivatives are highly costly and chemical intensive. Further the scaling up the graphene nanoplatelet production using available methods is cumbersome.

According to one embodiment herein, graphene nanoplatelet production is easily scaled up based on the requirement. The method can be utilized for the synthesis of graphene nanoplatelets, doped graphene nanoplatelets and functionalized graphene nanoplatelets. The method disclosed in the present invention, can be utilized for achieving graphene nanoplatelets with controllable dimension and crystallinity. The advantage of the method disclosed in the present invention is that the ceramic substrate is reusable. After shearing the ceramic particles are again carbonized and graphitized for the production of graphene nanoplatelets. Thus making the method cost effective.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope.

Although the embodiments herein are described with various specific embodiments, it will be obvious for a person skilled in the art to practice the embodiments herein with modifications.

What is claimed is:

1. A method of synthesizing graphene and a plurality of derivatives, the method comprising steps of:
synthesizing a ceramic substrate from a ceramic material in a particulate form, and wherein the ceramic material is selected from a group consisting of oxides of silicon, aluminum, zirconium, zinc, magnesium, and calcium;
depositing carbon material on the synthesized ceramic substrate to synthesize coated graphene ceramic substrate coated with a carbonaceous material, wherein the carbonaceous material is selected from a group consisting of glucose, lactose, fructose, coal tar, asphalt, and recycled plastics;
dispersing/dissolving the graphene ceramic substrate coated with the carbonaceous material in at least one solvent to obtain a dispersion solution, and wherein the at least one solvent is selected from a group comprising of acetone, ethanol, water, isopropyl alcohol (IPA), N-Methyl-2-pyrrolidone (NMP), dimethyl formamide (DMF), and dimethyl sulfoxide (DMSO);
subjecting the dispersion solution comprising the graphene ceramic substrate coated with the carbonaceous material dissolved/dispersed in the at least one solvent to a mechanical shearing process toe xfoliate graphene layers from the graphene ceramic substrate coated with carbonaceous material and wherein the step of exfoliating graphene layers comprises exfoliating graphene derivatives; and
processing the graphene derivatives by subjecting the exfoliated graphene layers to ultra-sonication technique to synthesize graphene nano-platelets.

2. The method of claim 1, wherein the mechanical sharing process is performed by rotating or stirring the dispersion solution at a rotation speed of 500 to 10000 rpm for a period of 1 to 5 hours to exfoliate graphene layers from the graphene ceramic substrate coated with carbonaceous material.

3. The method of claim 1, wherein a sheet thickness and a sheet diameter of synthesized graphene nano-platelets is dynamically controlled.

4. The method of claim 1, wherein a crystallinity of synthesized graphene nano-platelets is dynamically controlled by controlling stirring speed during the mechanical shearing process.

5. The method of claim 1, wherein the graphene ceramic substrate coated with carbonaceous material is chemically treated with sulphuric acid (H₂SO₄) resulting in increasing an oxygen percentage in the graphene nano-platelets, and wherein the chemical treatment of the graphene ceramic substrate coated with carbonaceous material is performed before starting the mechanical shearing process.

6. A system for synthesizing graphene and a plurality of derivatives through a mechanical shearing process, the system comprising:
a beaker to store a synthesized graphene ceramic composite with at least one solvent, and wherein the synthesized graphene ceramic substrate composite is obtained by synthesizing a ceramic substrate from a ceramic material in particulate form, depositing the carbon material on the synthesized ceramic substrate to synthesize carbonaceous material coated graphene ceramic substrate and wherein the ceramic material is selected from a group consisting of oxides of silicon, aluminum, zirconium, zinc, magnesium, and calcium, and wherein the carbonaceous material is selected from a group comprising of glucose, lactose, fructose, coal tar, asphalt, and recycled plastics, and wherein the at least one solvent is selected from a group consisting of acetone, ethanol, water, isopropyl alcohol (IPA), N-Methyl-2-pyrrolidone (NMP), dimethylformamide (DMF), and dimethyl sulfoxide (DMSO); and
a plurality of metallic blades coupled to a rotor through a cylindrical rod, wherein the plurality of metallic blades are rotated to cause an exfoliation of graphene layers from the graphene ceramic substrate by subjecting the graphene ceramic substrate coated with carbonaceous and dissolved in at least one solvent to a mechanical shearing process to exfoliate graphene layers from the graphene ceramic substrate coated with the carbonaceous material dissolved/dispersed in the at least one solvent.

7. The system of claim 6, wherein the metallic blades are rotated at a speed of 500 to 10000 rpm for a period of 1 to 5 hours to exfoliate the graphene layers, and wherein the exfoliating graphene layers comprise exfoliating graphene derivatives.

8. The system of claim 6 further comprises an ultrasonication unit to process the graphene derivatives by ultra-sonication technique to synthesize graphene nano-platelets, and wherein a sheet thickness of synthesized graphene nano-platelets is dynamically controlled, and wherein a sheet diameter of synthesized graphene nano-platelets is dynamically controlled, and wherein a crystallinity of synthesized graphene nano-platelets is dynamically controlled by controlling the stirring speed during the mechanical shearing process, and wherein the graphene ceramic substrate is chemically treated with sulphuric acid (H₂SO₄) to increase an oxygen percentage in the graphene nano-platelets, and wherein the chemical treatment is performed before starting the mechanical shearing process.

9. A method of synthesizing exfoliated doped graphene nano-platelets from doped graphene ceramic composite, the method comprises steps of:
washing and annealing particulate ceramic material for surface activation and removal of contaminants, and wherein annealing of the particulate ceramic material is performed at a temperature of 200° C.;
coating and carbonizing annealed particulate ceramic material with carbon source/precursors, and wherein the carbon source is selected from a group consisting of sucrose, fructose, lactose, coal tar, asphalt and recycled plastic;
functionalizing annealed particulate ceramic material in presence of graphene to obtain graphene ceramic composite, and wherein the graphene ceramic composite are subjected to graphitization, and wherein the functionalization comprises incorporating dopant in the graphene ceramic composite, and wherein carbonization of coated ceramic material is performed at a temperature range of 200-400° C., and wherein the graphitization is performed at a temperature range of 600-950° C. under atmospheric temperature;
doping the graphene ceramic composite with dopant precursor;
exfoliating the doped graphene ceramic composite by ultra-sonication and centrifugation to obtain graphene nano-platelets; and
reusing the particulate ceramic material again for the synthesis of graphene nano-platelets, and wherein the ceramic material is selected from a group consisting of oxides of aluminum, oxides of silicon, oxides of zinc, oxides of magnesium, oxides of calcium and oxides of zirconium, and wherein the ceramic material is a substrate on which graphene is grown.

10. The method according to claim 9, wherein the graphene ceramic composite is synthesized by coating carbon precursor on the ceramic material, and wherein the carbon precursor and the ceramic material is subjected to carbonatization and graphitization.

11. The method according to claim 9, wherein the step of doping the graphene ceramic composite with dopant precursor composition comprises the steps of:
treating graphene ceramic composite with a dopant precursor solution with the concentration of the dopant precursor solution in a range of 3% w/w-10% w/w with respect to graphene ceramic composite, and wherein the dopant precursor selected from a group consisting of boron, nitrogen and phosphorus, and wherein the dopant precursor solution is synthesized in solvents selected from a group consisting of hexamethyene-tetra amine and boric acid.

12. The method according to claim 9, wherein the step of functionalizing graphene ceramic composite comprises the steps of:
treating the graphene ceramic composite with acids, and wherein the acids are selected from a group consisting of H2SO4, HNO3, NaOH and KOH, and wherein the acids create a plurality of active site on the graphene ceramic composite surface; and
treating the graphene ceramic composite comprising a plurality of active sites with precursors/inorganic groups, and wherein the precursors are selected from a group consisting of EDTA, thiourea, Fe3O4, MnO2, and wherein the concentration of precursor is in a range of 0.5% w/w-5% w/w with respect to graphene ceramic composite, and wherein the functionalized graphene ceramic composite is exfoliated to obtain functionalized graphene nanoplatelets.

13. The method according to claim 9, wherein the step of exfoliating the doped graphene ceramic composite by ultra-sonication and centrifugation to obtain graphene nano-platelets comprises the steps of:
dispersing functionalized graphene ceramic composite in solvent/stabilizing agent in a metal beaker;
stirring the graphene ceramic composite in solvent/stabilizing agent in the beaker by a mechanical stirrer at 4000-5000 rpm, and wherein the mechanical stirrer shears the graphene ceramic composite particles;
collecting the solvent/stabilizing agent in a beaker;
ultrasonicating the collected solvent/stabilizing agent for 3-4 hours; and
centrifuging the ultrasonicated solvent/stabilizing agent to collect a plurality of layers of graphene nanoplatelets and separated ceramic composite, and wherein the layer of ceramic composite of separated from graphene nanoplatelets, and wherein mechanical shearing exfoliates graphene sheets from ceramic composite, and wherein the solvent/stabilizing agent is selected from a group consisting of water, acetone, ethanol, N-methyl-2-pyrrolidone (NMP), dimethyl sulfoxide (DMSO), isopropyl alcohol (IPA), dimethyl formamide (DMF).

14. The method according to claim 9, wherein the ceramic material is selected from a group consisting of oxides of aluminum, oxides of silicon, oxides of zinc, oxides of magnesium, oxides of calcium and oxides of zirconium.

15. The method according to claim 9, wherein the ceramic material is a substrate on which graphene is grown.
